(19) United States
(12) Patent Application Publication
(10) Pub. No.: US 2014/0268660 A1
(43) Pub. Date: Sep. 18, 2014

(54) NIGHT LIGHT

(71) Applicant: Chin-Sheng YANG, Tainan City (TW)

(72) Inventor: Chin-Sheng YANG, Tainan City (TW)

(21) Appl. No.: 13/798,153

(22) Filed: Mar. 13, 2013

(51) Int. Cl. F21V 31/04

(52) U.S. Cl. CPC F21V 31/04
USPC 362/101

(57) ABSTRACT

A night light includes a main pedestal arranged with a circuit set, wherein the main pedestal comprises a utility-power connector configured to couple with a power supply for power production, a light emitter electrically connected to the main pedestal, a casing covering a top portion of the main pedestal, wherein a groove is radially arranged at a wall of the casing, a fluid-ball body having a transparent solid structure, wherein the fluid-ball body comprises a flange fitting with the groove, wherein the flange of the fluid-ball body is secured to the casing, wherein a carrying portion is at the outer of the fluid-ball body, wherein a transparent cover is at the outer of the carrying portion, wherein an accommodating space is formed between the carrying portion and the transparent cover.

### BACKGROUND OF THE DISCLOSURE

a) Field of the Disclosure

The invention relates to a night light, and more particularly, to a night light not only having a function of illumination but gaining visual enjoyment by means of a fluid.

b) Brief Description of the Related Art

Generally, decorative accessories on the desktop are nothing more than picture frames, toys, etc., all of which are static ornaments with beautiful views. Water lamps with sequins, glitters or decorations internally are designed, wherein manually shaking inversely or electricity may lead sequins, glitters or decorations to move with a fluid so as to produce visual enjoyment. Visual effects vary with different objects in the water lamp, so various water lamps can be developed with a variety of visual changes, versatility or interests. Accordingly, designs for water lamps are expertise for a researcher of environmental decorations.

### SUMMARY OF THE DISCLOSURE

In accordance with the present invention, a night light includes a main pedestal arranged with a circuit set, wherein the main pedestal comprises a utility-power connector, configured to couple with a power supply for power production, at a side of the main pedestal, a light emitter arranged over the main pedestal and electrically connected to the circuit set of the main pedestal, a casing covering a top portion of the main pedestal, wherein a groove is radially arranged at a wall of the casing, wherein an opening is arranged at a top portion of the casing, and a fluid-ball body having a transparent solid structure, in which an airtight space is provided for containing a slightly viscous and flowable fluid, wherein the fluid-ball body comprises a flange fitting with the groove, wherein the flange of the fluid-ball body is secured to the casing, wherein a carrying portion is at the outer of the fluid-ball body, wherein a transparent cover is at the outer of the carrying portion, wherein an accommodating space is formed between the carrying portion and the transparent cover. The heat created by the illumination of the light emitter causes the fluid in the fluid-ball body to flow. Thereby, the night light not only has a function of illumination but gains visual enjoyment by means of the fluid.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematically perspective view in accordance with the present invention;

FIG. 2 is a schematically perspective exploded view in accordance with the present invention;

FIG. 3 is a cross-sectional view in accordance with the present invention;

FIG. 4 is a schematically perspective view in accordance with an embodiment of the present invention;

FIG. 5 is a cross-sectional view in accordance with an embodiment of the present invention; and

FIG. 6 is a cross-sectional view showing a carrying portion in accordance with an embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

Referring to FIGS. 1 through 3, in accordance with the present invention, a night light includes: a main pedestal 1 arranged with a circuit set 11, wherein the main pedestal 1 comprises a utility-power connector 12, configured to couple with a power supply for power production, at a side of the main pedestal 1; a light emitter 2 arranged over the main pedestal 1 and electrically connected to the main pedestal 1, wherein the light emitter 2 can be a light bulb or light-emitting diode, wherein the main pedestal 1 comprises a switch 13 having a terminal connected to the circuit set 11 and another terminal connected to the light emitter 2, wherein the switch 13 is configured to control the light emitter 2 to be turned on or off; a casing 3, shaped like a half cone, wherein the casing 3 has an open side 31 at a side of the casing, wherein an opening 32 is arranged at a top portion of the casing 3 and a gap 33 is arranged at a bottom portion of the casing 3, wherein the casing 3 covers a top portion of the main pedestal 1 with the gap 33 fitting with the top portion of the main pedestal 1, wherein a stop sheet 4 is arranged at an outside of the gap 33, wherein a groove 34 is radially arranged at an inner wall of the casing 3; a fluid-ball body 5 having a transparent solid structure, in which an airtight space is provided for containing a slightly viscous and flowable fluid, wherein the fluid-ball body 5 comprises a flange 51 fitting with the groove 34, wherein the flange 51 of the fluid-ball body 5 is secured to the casing 3 from the open side 31, wherein the stop sheet 4 abuts against the open side 31, wherein the fluid-ball body 5 includes a carrying portion 52 at the outer of the fluid-ball body 5, wherein a transparent cover 53 is arranged at the outer of the carrying portion 52, wherein an accommodating space 54 formed between the carrying portion 52 and the transparent cover 53 can accommodate a picture 7.

In accordance with the present invention, the light emitter 2 can be used to illuminate the fluid-ball body 5 so as to create gorgeous visual effects on the night light. The flowable fluid, such as methylene chloride, in the fluid-ball body 5 may have a low melting point. The heat created by the illumination of the light emitter 2 causes the fluid having a low melting point to flow. Thereby, the night light not only has a function of illumination but gains visual enjoyment by means of the fluid.

Referring to FIGS. 4 through 6, in accordance with the present invention, the casing 3 is shaped like a funnel. A background picture 8 showing undersea landscapes, flowers or stars can be attached to a backside of the fluid-ball body 5. The whole appearing in accordance with the present invention can provide another visual effect due to the transparency of the fluid-ball body 5. The picture 7 in the accommodating space 54 can accordingly display a visual effect of alternating backgrounds.

Referring to FIG. 5, the carrying portion 52 of the fluid-ball body 5 can protrude from the fluid-ball body 5. Alternatively, referring to FIG. 6, the carrying portion 52 of the fluid-ball body 5 can be recessed from the fluid-ball body 5. When the picture 7 in the accommodating space 54 is changed, just the cover 53 is detached. Thereby, the picture 7 can be easily changed.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A night light comprising:
a main pedestal arranged with a circuit set, wherein the main pedestal comprises a utility-power connector, configured to couple with a power supply for power production, at a side of the main pedestal;
a light emitter arranged over the main pedestal and electrically connected to the circuit set of the main pedestal;
a casing covering a top portion of the main pedestal, wherein a groove is radially arranged at a wall of the casing, wherein an opening is arranged at a top portion of the casing;
a fluid-ball body having a transparent solid structure, in which an airtight space is provided for containing a slightly viscous and flowable fluid, wherein the fluid-ball body comprises a flange fitting with the groove, wherein the flange of the fluid-ball body is secured to the casing, wherein a carrying portion is at the outer of the fluid-ball body, wherein a transparent cover is at the outer of the carrying portion, wherein an accommodating space is formed between the carrying portion and the transparent cover.

2. The night light of claim 1, wherein the light emitter comprises a light bulb or light-emitting diode.

3. The night light of claim 1, wherein the carrying portion protrudes from the fluid-ball body.

4. The night light of claim 1, wherein the carrying portion is recessed from the fluid-ball body.

5. The night light of claim 1, wherein the casing has an open side, wherein the fluid-ball body is secured to the casing from the open side, wherein a stop sheet abuts against the open side.

6. The night light of claim 1, wherein the main pedestal comprises a switch having a terminal connected to the circuit set and another terminal connected to the light emitter, wherein the switch is configured to control the light emitter to be turned on or off.
